(19) United States
(12) Patent Application Publication
(10) Pub. No.: US 2015/0269830 A1
(43) Pub. Date: Sep. 24, 2015

(54) ROOF MONITORING METHOD AND SYSTEM

(71) Applicant: Beldon Technologies, Inc., San Antonio, TX (US)

(72) Inventor: Bradford Beldon, San Antonio, TX (US)

(21) Appl. No.: 14/660,507

(22) Filed: Mar. 17, 2015

Related U.S. Application Data
(60) Provisional application No. 61/955,168, filed on Mar. 18, 2014.

(51) Int. Cl. G08B 21/18; G08B 5/36

(52) U.S. Cl. CPC G08B 21/182; G08B 5/36

(57) ABSTRACT

Methods, systems, and apparatus, including computer programs encoded on a computer storage medium, for monitoring a load condition over a specified area In one aspect, a load sensor comprises: a protective top cover having a load transfer assembly; a bottom plate attachable to the top cover; the bottom plate including a circuit board comprising; a load sensor, a power source; and a wireless processor; wherein the circuit board is configured on the bottom plate such that the load transfer assembly of the top plate is in contact with the load sensor.

### CROSS REFERENCE TO RELATED APPLICATION

International Publication No. WO 2011/133942 is incorporated herein in its entirety, and included as Enclosure 1.

### BACKGROUND

This specification relates to a system and method of monitoring loading conditions on a structure. More specifically, this specification relates to a method and system of monitoring roof loading conditions and reporting such conditions to a network or user.

A structural member such as a roof may experience loads due to external forces acting on an exterior surface, such as snow or rain fall, standing water, or wind. Load accumulation may be indicative of other problems, such as ice damming or other accumulation. Sufficient load accumulation may cause the structure to catastrophically fail, thereby endangering occupants.

Structures with large surface areas can experience significant load conditions due to environmental factors. In many areas of the world, snow removal is necessary from the roofs of large structures in order to prevent structural damage and collapse. Snow removal from such structures is labor intensive, dangerous, and expensive. But there is a yet a system or technology to effectively measure various load conditions and report when snow removal or otherwise dangerous loading conditions are present. Moreover, a predictive system that can alert users well before dangerous conditions exist would be desirable along with the ability to monitor such load conditions remotely or from a site removed from the monitored structure.

Other hazardous situations occur on the structure or involving persons on the structure. For example, given the height and exposure of the roof surface, high winds or sudden storms may cause damage to the roof or materials on the roof. A roof sensor that alerts building operators and owners when wind gusts or sustained winds exceed a predetermined level would be advantageous. In addition, a roof sensor system that monitors sudden changes in barometric pressure would be advantageous in predicting severe local conditions, such as tornadoes and microbursts.

Roof edges are a particularly dangerous area for anyone working on the roof of a building. A roof sensor system that includes a pressure sensor to alert individuals, building owners, and tenants when an individual is near the roof edge would be desirable. In addition, many roofs include sensitive areas and machinery, for example entry points into the buildings, antennae, security cameras, signage, and audio-visual systems. A sensor array around such sensitive areas to provide building operators notification of authorized or unauthorized persons on those portions of the roof would be advantageous.

### SUMMARY

This specification describes technologies relating to remote monitoring of load conditions across a specified area and reporting load conditions over a network.

In general, one innovative aspect of the subject matter described in this specification can be embodied in methods that include the actions of: periodically monitoring the load condition over a specified area using one or more networked load sensors; connecting a load sensor with a local network, receiving at sensor base station a load condition measured by at least one load sensor; processing the load condition and determining whether such load condition is within a specified parameter; reporting the load condition to a user over a network. Other embodiments of this aspect include corresponding systems, apparatus, and computer programs, configured to perform the actions of the methods, encoded on computer storage devices.

In another example embodiment of the present invention a load sensor comprises: a protective top cover having a load transfer assembly; a bottom plate attachable to the top cover; the bottom plate including a circuit board comprising; a load sensor, a power source; and a wireless processor; wherein the circuit board is configured on the bottom plate such that the load transfer assembly of the top plate is in contact with the load sensor.

In yet another example embodiment of the present invention, a system comprises a sensor array having one or more load sensor, wherein the load sensors comprise a protective top cover having a load transfer assembly; a bottom plate attachable to the top cover; the bottom plate including a circuit board comprising; a load sensor, a power source; and a wireless processor; wherein the circuit board is configured on the bottom plate such that the load transfer assembly of the top plate is in contact with the load sensor; the load sensors are in wireless communication with a base station server, wherein the base station server receives periodic load condition reports from the load sensors in the sensor array, processes the load conditions into a user readable report and transmits the user readable report to a user terminal over network. The base station server can also receive instructions or information from terminals via the network; process the information or instructions to reconfigure the operation of one or more sensors in the sensor array; and transmit operating instructions the sensors over a wireless network.

Particular embodiments of the subject matter described in this specification can be implemented so as to realize one or more of the following advantages. A specified area can be monitored for load conditions or other environmental conditions according to a predetermined schedule. Sensors can be programmed to activate, report information, receive information, and deactivate on a preset schedule in order to preserve battery life. Sensors can be interchanged. Load conditions can be monitored on a variable schedule based on information determined by the sensors or on information provided from an outside source. Load conditions can be monitored well before a critical condition occurs. Snow removal from a roof surface can be done based on actual load conditions, preventing unnecessary cost and resource expenditure. Specific areas within a sensor array can be identified as having an alarm condition. Load conditions can be monitored remotely. Sensors can be activated on user command, or in response to an external condition.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example embodiment of a sensor unit of the present invention.

FIG. 2 is a top view of an example embodiment of a sensor unit of the present invention.

FIG. 3 is an internal top view of an example embodiment of the present invention.

FIG. 4 is an example embodiment of system of sensor units of the present invention.

FIG. 5 is an example embodiment of a method of the present invention.

FIG. 6 is an example embodiment of a method of the present invention.

FIG. 7 is an example embodiment of a method of the present invention.

FIG. 8 is an example system of the present invention.

FIG. 9 is an example method of the present invention.

FIG. 10 is an example embodiment of a sensor of the present invention.

FIG. 11 is an example embodiment of a sensor of the present invention.

FIG. 12 is an embodiment of a sensor of the present invention.

FIG. 13 is an embodiment of a sensor of the present invention.

Like reference numbers and designations in the various drawings indicate like elements.

### DETAILED DESCRIPTION

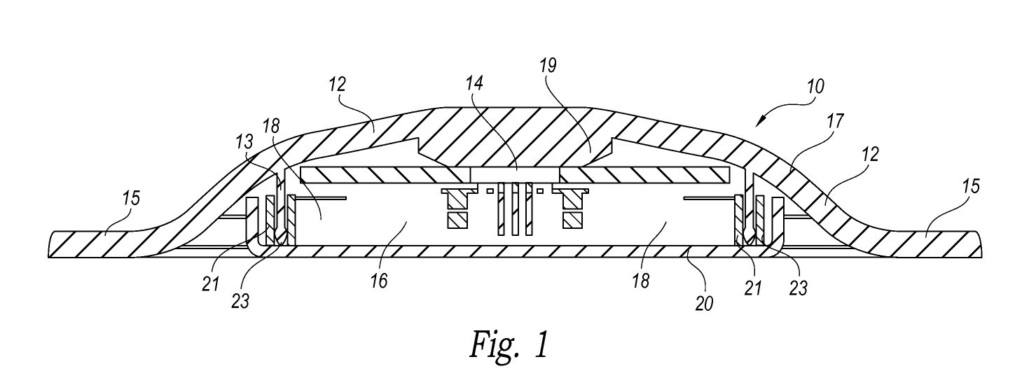

As shown in FIG. 1, a sensor unit 10 comprises a top cover 12, a load sensor 14 a circuit board 16, and bottom plate 20. Top cover 12 may further comprise retention ring 13, stability flange 15, and raised sidewalls 17. Bottom plate 20 may further comprise retention rings 21 and 23. The top cover 12 and bottom plate 20 are configured to connect and form a single unit. Connection can be by snap connectors, friction connectors, screws, brackets or any other suitable connection. Retention ring 13 of top cover 12 can be configured to work cooperatively with retention ring 21 and 23 of bottom plate 20 to provide proper alignment and connection between top cover 12 and bottom plate 20. Snap connecting means, friction connecting means, screw holes, and the like can be incorporated into the structure of the retention rings 13, 21 and 23 to provide a secure assembly of the sensor unit 10. In some embodiments one or more O-rings are provided in and around the retention rings 13, 21, and 23 to ensure moisture or other contaminants do not enter the sensor unit 10. In some embodiments, when bottom plate 20 is attached to top cover 12, a watertight interior space 18 is provided.

Sensor unit 10 can be secured to a surface for monitoring load conditions on that surface in any number of means, including providing screw fittings in stability flanges 15 to screw the sensor unit 10 to the monitored surface. In one embodiment a bracket is provided to mount around stability flange 15, there by facilitating easy removal, maintenance or replacement of sensor unit 10.

Top cover 12 and bottom plate 20 may comprise a durable plastic or composite material resistant to temperature, moisture, UV degradation, the effects of wind, rain, snow, hail, sleet, ice, dust, and insects and other pests. Top cover 12 or bottom plate 20 may include one or more vents. In some embodiments the vent is a moisture proof barrier that facilitates pressure equalization between the interior of the sensor unit 12 and the ambient atmospheric pressure. The VE Series Adhesive Vent by Gore® is an example of such a self-balancing vent. In some implementations of the present invention, a moisture proof adhesive layer can be included on the bottom surface of top cover 12 and bottom plate 20 to prevent moisture or other foreign objects from entering the interior of the device, through for example, the space where the top cover 12 and the bottom plate 20 join.

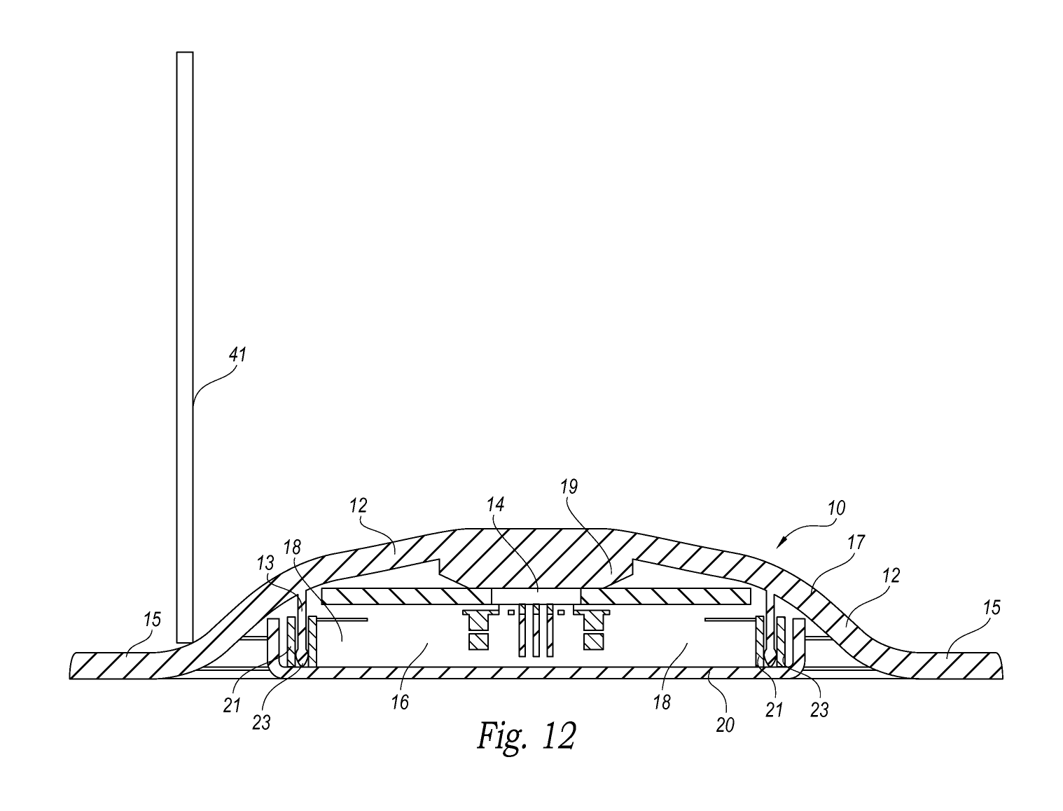

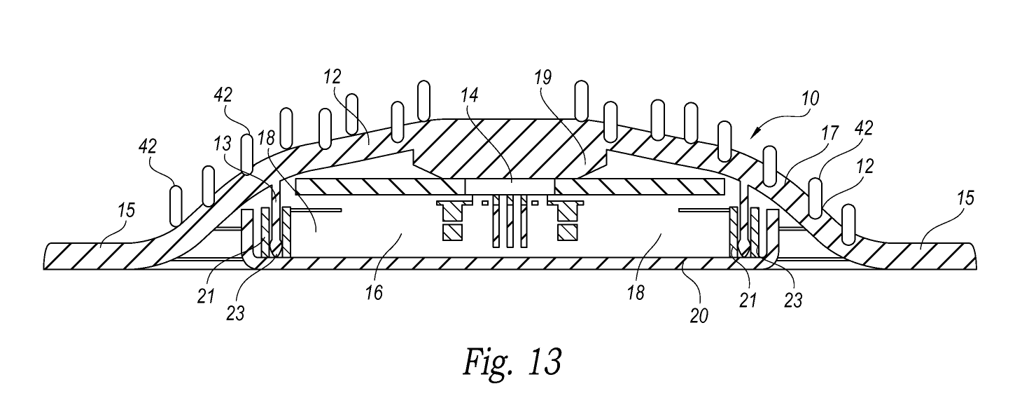

In one example implementation sensor 14 is not in direct contact with the ambient environment but instead is in contact with load transfer assembly 19 which is integral to top cover 12. In such an arrangement, sensor 14 is protected from blunt strikes as experienced by hail and sleet, as well as uneven loading, for example from an inadvertent step by a person walking on the surface. Top cover 12 can include one or more additional features. FIG. 11 illustrates a load sensor 10 having a top cover 12 and an antennae 41 extending vertically from the outer surface of top cover 12. Antennae 41 provides a visual reference and identifies the location of sensor 10 when sensor 10 is buried in snow, submerged in standing water, or obstructed by debris. FIG. 12 illustrates a load sensor 10 having a series of protrusions 42 extending outwardly from outer surface of top cover 12. The protrusions 42 can lessen the impact of hail, sleet, rain or other falling object that may strike top cover 12. Protrusions 42 also divert water in an irregular pattern from the surface of top cover 12.

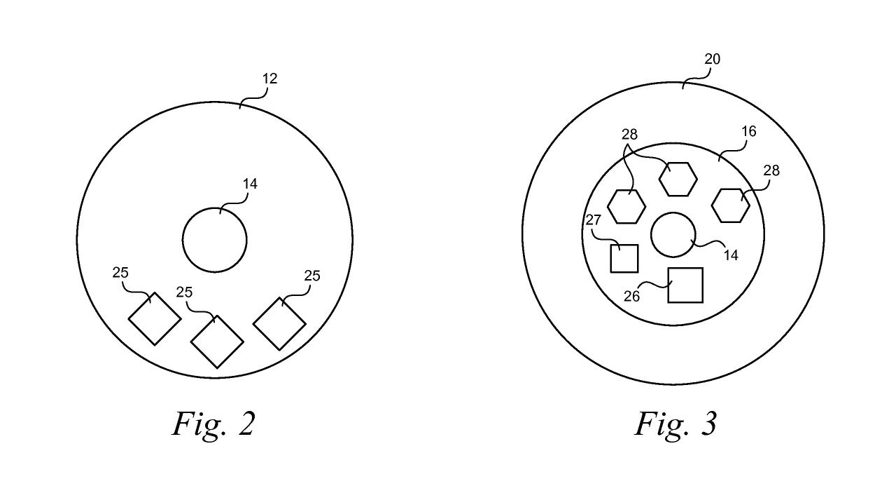

FIG. 2 shows a top view of one example implementation of a sensor unit 10 comprising a load sensor cover 14 and one or more solar panels 25. Sensor unit 10 can be provided with or without sensor solar panels 25.

FIG. 3 shows an internal top view of bottom plate 20 including circuit board 16, sensor 14, Wi-Fi processor 26, secondary processor 27, and one or more batteries 28. Load sensor is configured to detect a static or dynamic load, and can be any standard load cell. Various details of an example load sensor are disclosed in International Publication No. WO 2011/133942 A2, entitled Surface Mounted Monitoring System, incorporated herein by reference and included with this filing as Enclosure 1. Circuit board 16 also includes one or more processors, such as Wi-Fi processor 26 and secondary processor 27. In some embodiments, processors associated with circuit board 16 can be GPS enabled, control secondary sensors such as time, temperature, barometric pressure, dew point, humidity, pollen count, UV intensity, contaminant levels, chemical levels, radiological levels and the like. Circuit board 16 may further include any number of alarms and indicators, such as visual indicators in the form of lights, flags, barber poles, or tabs and audio indictors such as bells, alarms, sirens, or speakers. Such indicators can be used to indicate operational status, battery life, connectivity to a network, presence of an alarm condition, for example a load within or over a specified parameter.

Load sensor 10 is configured to operate in a network or array of load sensors to measure the load over a specified area, such as a large flat roof or other structure concerned with loads due to snow, standing water, wind or other forces.

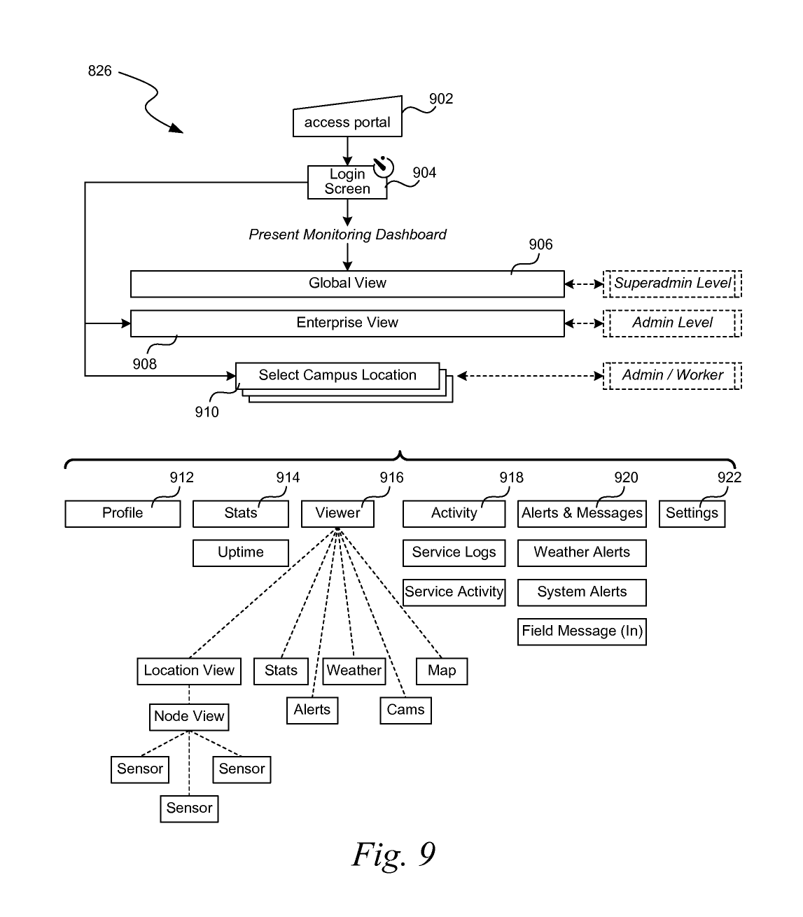

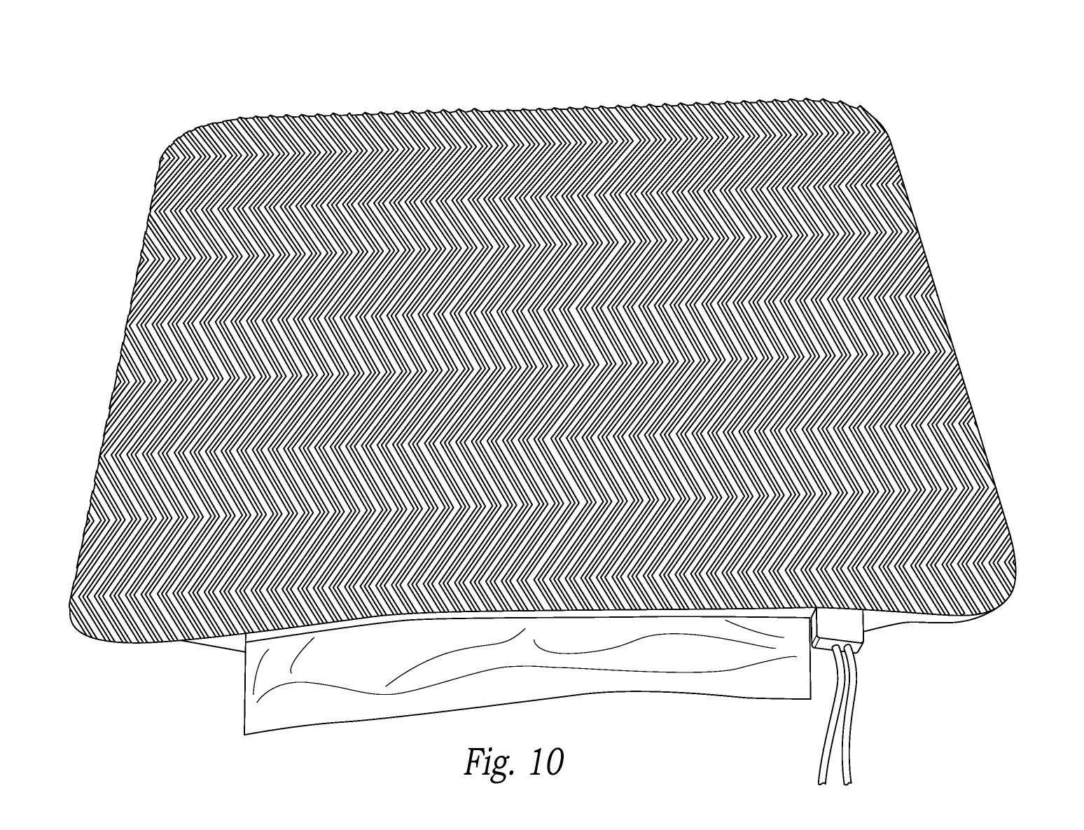

FIG. 9 illustrates an alternate embodiment of a sensor that can be incorporated into example implementations of the present invention. Sensor mat 900 comprises a substantially flat, low profile sensor mat 910 that can be secured to the roof surface by conventional methods and includes a pressure sensor capable of detecting a load, in particular, capable of detecting a foot step. Mat 910 can be hard wired to a central server and power source or can include a wireless transceiver and a battery power supply. Mat 910 can be incorporated into a system to alert an alarm system when a person or animal has stepped on the mat. Such a warning mat can be included at the edge of buildings, around doors, skylights, antennae, signage, cameras, audio equipment, or other sensitive areas to alert building managers when an individual is in the vicinity of such a sensitive area. Mat 910 can be used simultaneously with previously described load sensors to provide a more robust roof monitoring system.

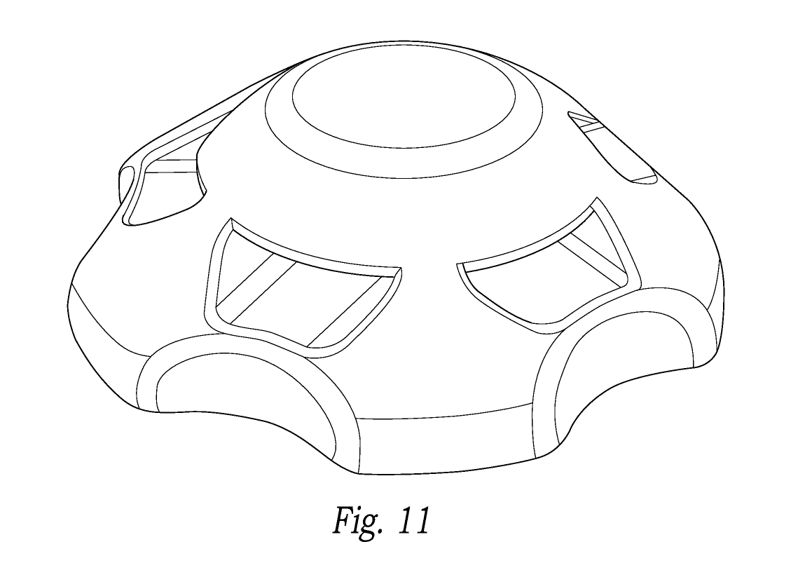

In addition to roof load sensors 10 and sensor mat 910, a wind sensor and barometer can be included in the roof monitoring system of the present invention. A wind sensor is similar to roof load sensor 10 and further includes one or more slots to allow wind to enter the interior portions of the sensor housing. Wind speed can be measured and transmitted to a central server. FIG. 10 illustrates one example embodiment of a wind sensor 1010. In still other embodiments, a barometer can be incorporated into the sensor array of the roof monitoring system of the present invention.

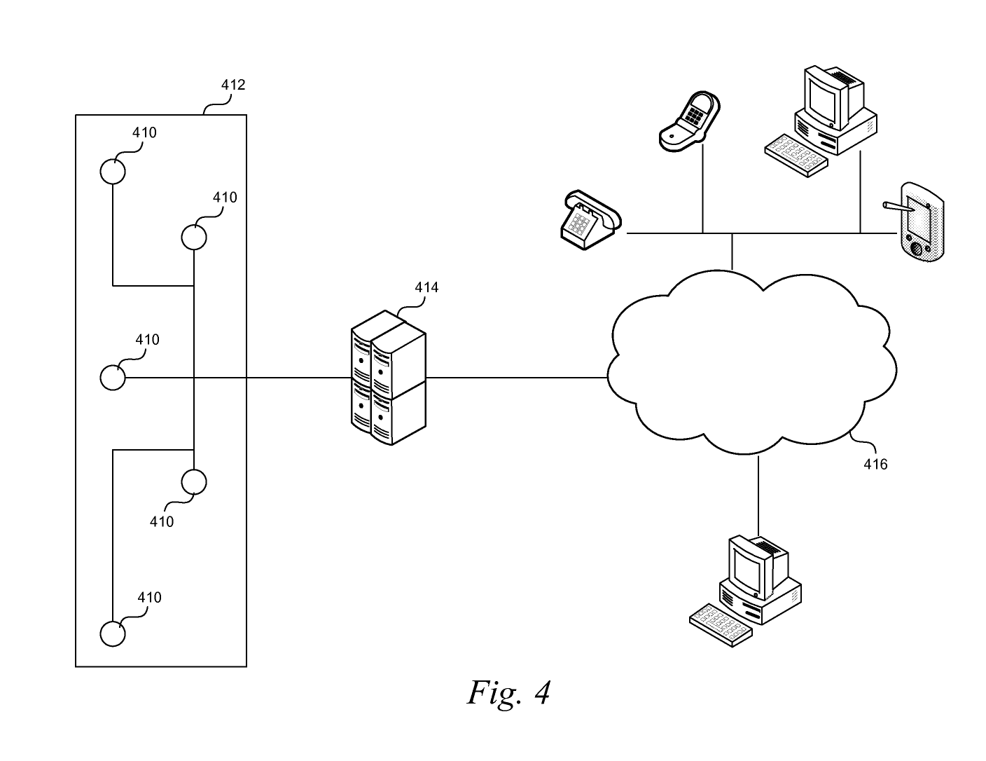

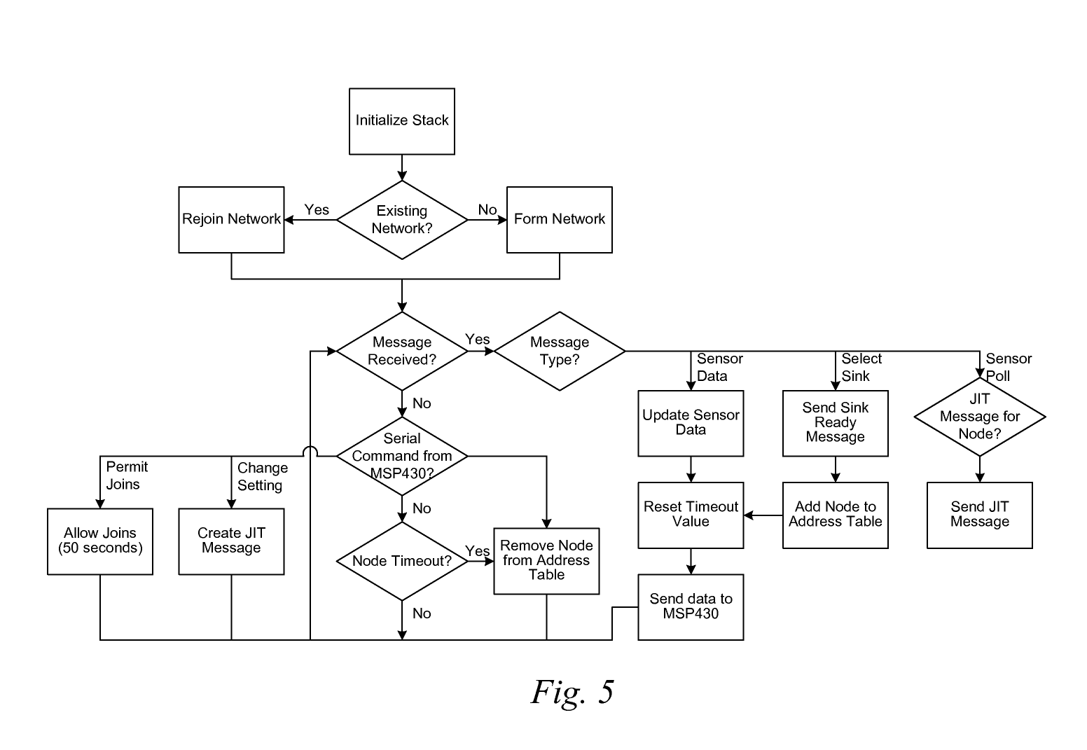

FIG. 4 illustrates an example implementation of a sensing system 400 including an array 412 of one or more load sensors 410 in communication with a server 414 and network 416. Array 412 includes one or more load sensors to measure a load condition, or any other desired condition, such as safety mats, wind speed, and barometric pressure as described above. Load sensors 412 are in communication via wireless network with system server 414. The wireless network can use any wireless standard including Bluetooth, Wi-Fi or ZigBee. ZigBee is a specification for a suite of high level communication protocols using small, low-power digital radios based on an IEEE 802 standard for personal area networks.

Server 414 is in communication with a larger network 416, such as the Internet, a cellular network, or a private network. Server 414 can send information received from sensor array 412 to other terminals and users also connected to the network and can configure messages to be received by users at a telephone 421, cellular telephone or smart phone 422, computer terminal 423, or a tablet or other computing device 424. Messages and information can be sent in the form of an e-mail, an instant message, a telephone call, a posting to a webpage, a page, or any other network based communication. Server 414 can also receive messages and information over the internet such as system configuration commands and instructions initiated by a system administrator (e.g., turn sensors on, turn sensors off, change sensor reporting parameters, requests for historical or real time reports pertaining to sensor readings, sensor operation or maintenance, etc.), or information of general relevance to the operating environment of the sensor array (e.g., weather data).

In one example of an operating system, sensor array 412 detects an alarm condition, such as a load condition within a specified range and the sensor or sensors detecting the alarm condition establish a connection over the wireless network with server 414 and report specified information such as the sensor ID, alarm condition triggered, load measurement, battery life, etc. Server 414 then sends a report to specified users over network cloud 416.

FIG. 5 illustrates an example implementation of a server (such as server 414 in FIG. 4) acting as a base station coordinator to manage the operation and data collection capabilities of the sensor array.

Upon initialization, the base station coordinator initializes its network stack and checks for the presence of an existing network. If an existing network is detected, the base station coordinator rejoins this network. If an existing network is not detected, it forms a new network and joins this new network.

Upon joining a network, the base station coordinator checks if any messages have been received from the network. If a network message has been received, the base station coordinator performs various functions depending on the type of message received.

If the network message pertains to sensor data from a particular node, the base station coordinator extracts the sensor data from the message, updates its database with the new sensor data, and resets the timeout value of the sensor node.

If the network message pertains to the syncing of a sensor node, the base station coordinator sends a “sync ready” message to the sensor node, acknowledging that the base station coordinator is ready for syncing. The base station coordinator then adds the address of the sensor node to the address table, and resets the timeout value of the sensor node.

If the network message pertains to sensor polling, the base station generates a just-in-time (JIT) message directed at a particular sensor node, requesting that the sensor node send a response. The base station sends the JIT message and awaits a response.

If the base station coordinator did not receive a message, the base station determines if a serial command has been sent from the MSP430 microcontroller. If a serial message has been received, the base station coordinator performs various functions depending on the type of message received.

If the serial message pertains to a request for network joining authorization, the base station controller allows joins to the network for a pre-determined period of time. For instance, the base station controller may allow join to the network for a period of 60 seconds.

If the serial message pertains to changing the settings of a sensor node, the base station coordinator creates a JIT message directed at a particular sensor node, indicating that particular parameters or settings need to be changed on the sensor node. The base station sends the JIT message and awaits a response.

If the serial message pertains to removing a sensor node from the network, the base station coordinator removes the address of the sensor node from the address table.

If the base station coordinator did not receive a serial message from the MSP430 microcontroller, the base station coordinator determines if any of the connected sensors nodes have exceeded a pre-determined timeout period. If so, the addresses of any timed out sensor nodes are removed from the address table. If not, no addresses are removed.

Upon completion of any of the above tasks, data relating to the completed task is sent to the MSP430 microcontroller for additional processing, transmission to other system components, or broadcast to other systems.

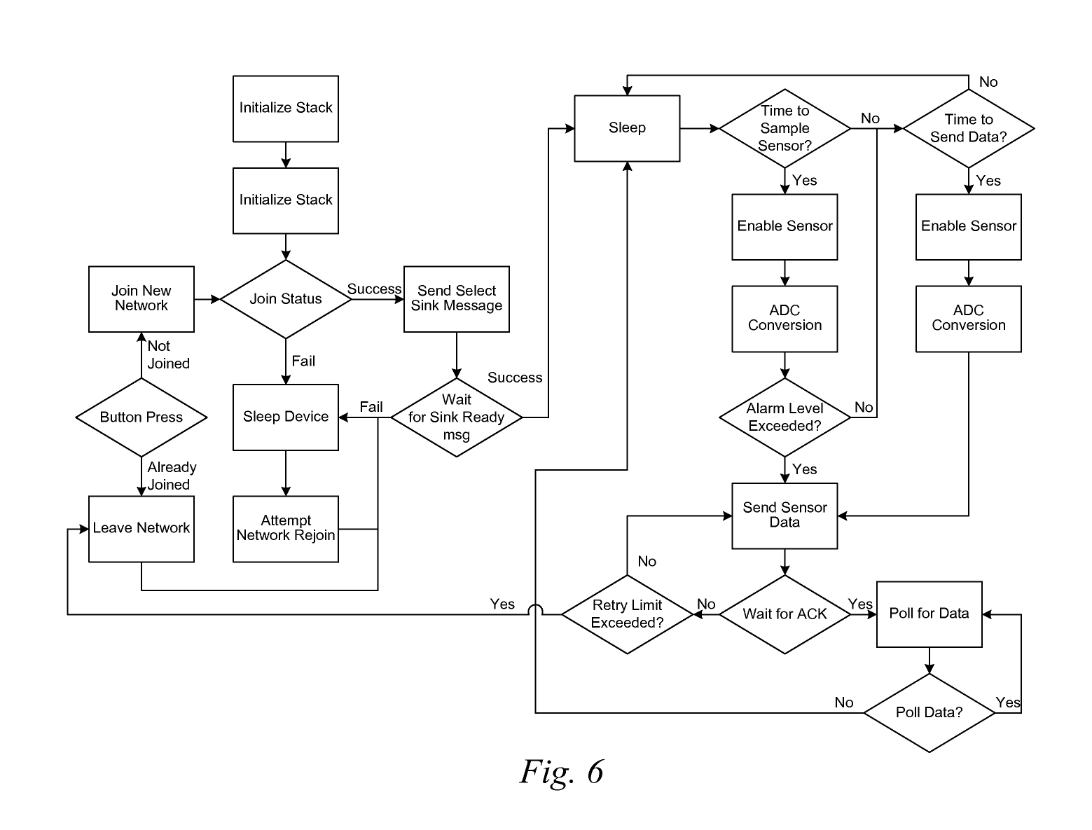

FIG. 6 illustrates an example implementation of a sensor board end device to collect and transmit sensor data from the sensor node and to manage the power saving functions of the sensor node.

Upon initialization, the sensor board end device initializes its network stack and attempts to rejoin its last joined network. If the rejoin attempt is unsuccessful, the sensor board enters a low-power sleep state. After a pre-determined period of time, the sensor board will awake and reattempt to network a network.

The sensor board may also be manually awoken by a user through a button press on the sensor board. If the sensor board is successfully connected to a network, the sensor board will leave the network and reenter the sleep state. On the other hand, if the sensor board is not connected to a network, it will attempt to join a new network.

If during this process the attempt to join a network is successful, the sensor board sends a sync message to the base station coordinator indicating that the network join was successful, then waits for a “sync ready” response message from the base station coordinator. If the “sync ready” response message is not received after a pre-determined length of time, the sensor board reenters the sleep state.

If the “sync ready” response message is successfully received, the sensor enters a network-connected sleep state. During the network-connected sleep state, the sensor board will periodically check if a pre-determined sample time has elapsed. If it has, the sensor board awakes from the low power state and uses an analog-to-digital converter (ADC) to convert analog data from its sensor component into a digital representation.

The sensor board then determines if a pre-defined alarm level has been exceeded. In some embodiments, this alarm level may correspond to a pre-determined threshold of force that is applied to the sensor component, indicating an unsafe amount of load on the sensor.

If this alarm level has been exceeded, the sensor board transmits the sensor data to the base sensor coordinator and awaits the receipt an acknowledgement message. If an acknowledgement message is not received, the sensor board continues to retry sending the sensor data until an acknowledgement message is received, or until it exceeds a pre-determined number of failed transmission attempts. If the pre-determined number of failed transmission attempts is exceeded, the sensor board leaves the network and enters the sleep state described above.

If instead an acknowledgement message is received, the sensor board determines if the acknowledgement message includes a request for data polling. If so, the sensor continuously acquires data and transmits data in a data polling state for a pre-determined amount of time, or until a message is received to discontinue data polling. If data polling is not requested, or if data polling has ended, the sensor board returns to the network-connected sleep state.

If, during the network-connected sleep state, the sensor board determines that if a pre-determined sample time has not yet elapsed, or if the sensor board determines that ADC-converted data does not exceed the alarm level, the sensor board determines if a pre-determined data transmission time has elapsed. If not, the sensor board enters the network-connected sleep state. If so, the sensor board is awoken from network-connected sleep state (if necessary), uses the ADC to convert analog data from its sensor component into a digital representation, and attempts to send the digitized sensor data to the base station controller, in the manner described above.

In some embodiments, each of the pre-determined values may be set and altered through JIT messages sent from the base station controller. These pre-determined values may include the time between sensor samples, the time between data transmission, the acknowledgement wait time, the alarm level threshold, the data polling period, and the “sync ready” wait time.

The low power sleep states described above may be implemented using low power mechanisms described in various standard networking specifications. For example, various implementations of low power Wi-Fi networking are described by the IEEE Standards Association in IEEE 802.11-1997, IEEE 802.11a-ae, and IEEE 802.11 DCF, including the use of power save mechanisms (PCMs) to transition devices between a sleep state and an active transmission state. Other low power networking implementations are described by Bluetooth SIG in Bluetooth Specification v4.0 and the IEEE Standards Association in 802.15.4.

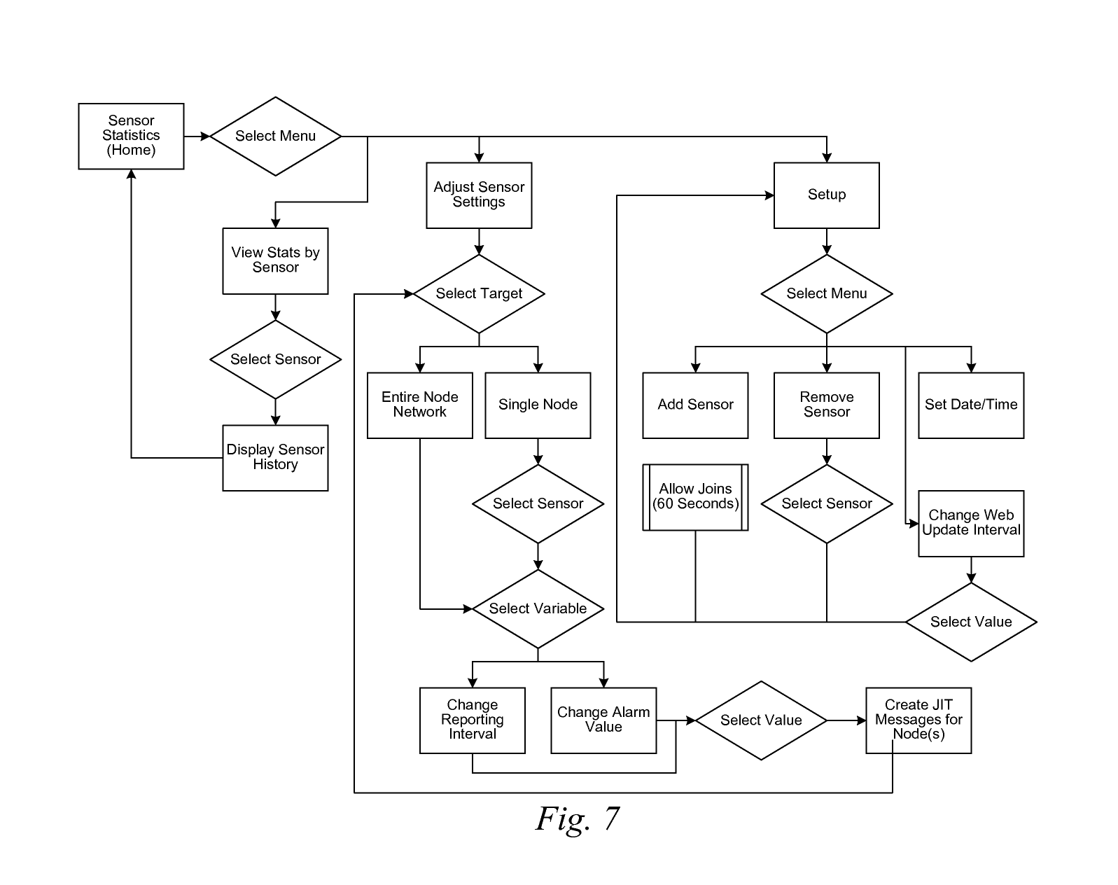

FIG. 7 illustrates an example method by which a user can monitor load conditions measured at one more sensors in a sensor array. Users can access sensor statistics and historical information for each sensor in the array. Users can adjust sensor settings for all sensors in the array, groups of sensors in the array, or individual sensors in the array. Sensor settings can include measurement type (e.g., load, temperature, barometric pressure, vibration, humidity, dew point, noise level, contaminant or particulate level, etc.). Sensor settings can also include reporting or activation intervals or alarm values. Users can also add sensors to the array, remove sensors from the array, establish operating and reporting parameters and the like.

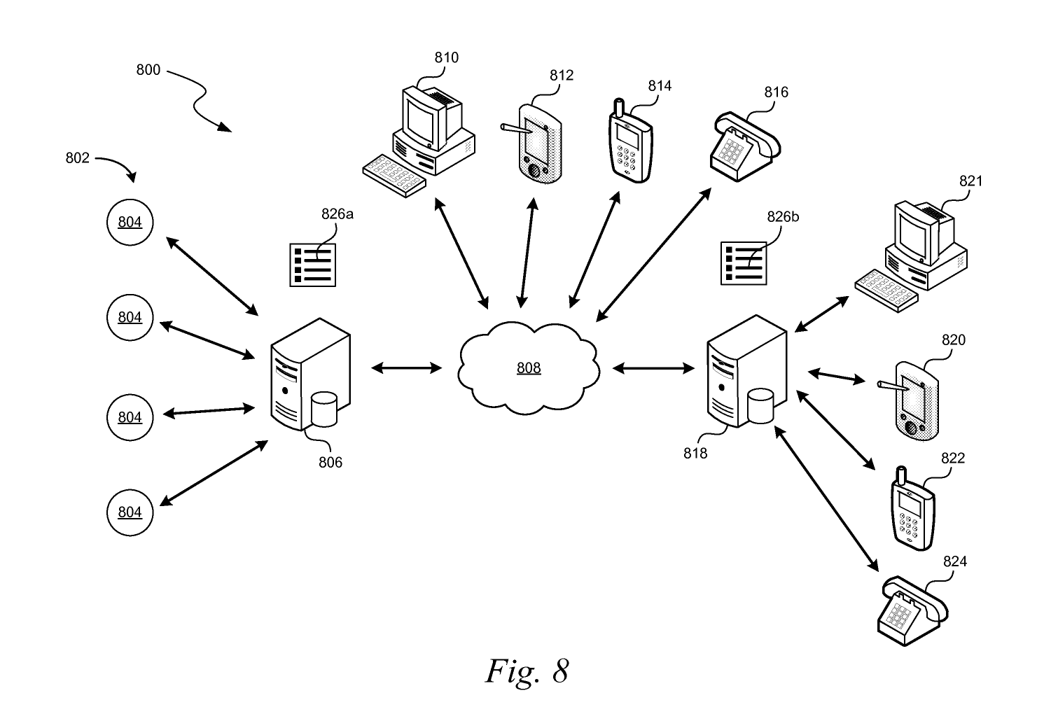

FIG. 8 illustrates another example implementation of a sensing system 800. Sensing system 800 includes an array 802 of one of more sensors 804 in communication with server 806. Sensors 804 can measure a variety of conditions, for instance a load condition (e.g., a load applied over a specified area), and/or other conditions, for instance wind speed, water level, temperature, barometric pressure, dew point, humidity, pollen count, UV intensity, contaminant levels, chemical levels, radiological levels, and any other environmental condition. In an example implementation, sensors 804 are placed on a building (e.g., on the roof of the building), and can be used to measure the load condition of the roof, the wind speed at the roof, and the level of water present on the roof. In some implementations, sensors 804 can be placed in other locations in order to obtain measurements from other areas of the building. For instance, in some implementations, sensors 804 are placed within a water drain in order to obtain measurements regarding to water level within the drain. In a similar manner, sensors 804 can be placed wherever measurement data is desired.

Sensors 804 can be powered in a variety of ways. For instance, in some implementations, sensors 804 can be powered by an external power source (e.g., an electrical grid or generator) connected to sensors 804 through a wired or wireless inductive connection. In some implementations, sensors 804 can be powered by an internal power source (e.g., a battery) that is recharged periodically through a wired or wireless inductive connection to an external power source. In other implementations sensors 804 can be powered by solar cells and batteries.

In some implementations, sensors 804 can adapt to a variety of operating conditions. For example, in some implementations, sensors 804 can measure a load condition by measuring a pressure applied to pressure-sensitive portion of sensor 804. This pressure-sensitive portion can be zero balanced, such that the measurements obtained by sensor 804 account for changes in the ambient environmental pressure. As an example, the pressure-sensitive portion can be zero balanced based on the altitude at which sensor 804 is used, and can be re-balanced if the sensor is moved to a higher or lower altitude.

In some implementations sensor 804 can include a moisture proof vent which allows the interior pressure of sensor 804 to self-balance with ambient pressure conditions. An example of such moisture proof self-balancing pressure vents are the VE-Series of Adhesive Vents by Gore®.

Sensors 804 are in communication with server 806 via a network, and information can be exchanged between sensors 804 and server 806. Information can include, for example, data corresponding to measurements from sensors 804, the location of sensors 804, the operational status of sensors 804, and commands that specify or modify the behavior of sensors 804. The network can be implemented using any wired or wireless protocol. For instance, in some implementations, sensors 804 communicate with server 806 through networks implemented using wireless standards such as Bluetooth, Wi-Fi, cellular, ZigBee, Near-Field Communications (NFC), radio-frequency identification (RFID), and other wireless standards. In some implementations, sensors 804 communicate with server 806 through networks implemented using wired standards, for instance Ethernet, serial, USB, or other wired standards. In some implementations, sensors 804 can communicate with server 806 through multiple networks, and each network can be implemented using different wired and/and wireless standards.

Server 806 is in communication with a larger network 808, for instance the Internet, a cellular network, or a private network. Server 806 can send information received from sensor array 802 to other terminals and users also connected to the network 808. For example, server 806 can send information as a text, image, video, or/and voice message to a computer 810, a tablet or other computing device 812, a smartphone 814, or a telephone 816. Server 806 can send information continuously, periodically, or intermittently. In some implementations, server 806 can send information when certain criteria are met. For instance, in some implementations, server 806 sends information when measurements from sensors 804 exceed a particular threshold, depart from a particular range of values, or according to other such criteria. In one example, server 806 can send information periodically to the computer 812, and can send additional information when measurements from sensors 804 exceed a threshold value.

In some implementations, server 806 can send messages to other terminals and users based on certain criteria. For instance, in some implementations, server 806 can send messages based on a list of points of contact. In some implementations, the server 806 can select one or more contacts from the list based on priority criteria, and select other contacts if the initial contacts are unavailable. In this manner, the server 806 can prioritize its notification attempts, without needlessly attempting contact with all contacts on the list. The priority criteria can be pre-determined criteria (e.g., a sequential list of contacts of descending priority), or the priority criteria can be determined based on other factors (e.g., the content of the message, the time of day, the day of the week, the type of communications method being used, the location of the sensor corresponding to the measurement, and so forth).

In some implementations, the server 806 can select one or more contacts from the list based on other criteria. For example, if sensors 804 obtain measurements indicating that a particular building is in a critical condition (e.g., experiencing excessive load, wind, or water conditions), server 806 can select contacts from the list based on which contacts would be affected by this critical condition. As an example, the server 806 can attempt to contact the owner or administrator of the building, people who live or work in the building, service or emergency response organizations, and so forth. The server 806 can also attempt to contact users who would be indirectly affected by the critical condition. For example, if the monitored building is a warehouse, the server 806 can contact users or organizations who were expecting items from the warehouse, informing them of potential delays.

In some implementations, server 806 can communicate with another server 818. Server 818 also can send information as a text, image, video, or/and voice message in a similar manner as server 806, and can send information, for example, to a computers 810 and 818, tablets or other computing devices 812 and 820, smartphones 814 and 822, or telephone 816 and 824. In some implementations, server 806 and server 818 can be operated and/or maintained jointly, for example by the same user(s) or organization(s). In some implementations, server 806 and server 818 can be operated and/or maintained separately by different user(s) or organization(s). As an example, server 806 can be operated by the administrator of a building being monitored, while server 818 can be operated by a separate monitoring organization. In another example, server 806 and server 818 can be operated jointly, for example by a monitoring organization or the administrator of a building being monitored.

In some implementations, server 806 or 818 can include a monitoring module 826. For example, referring to FIG. 8, server 806 can include a monitoring module 826a, and server 818 can include a monitoring module 826b. A user can interact with a monitoring module 826 in order to obtain information about system 800. Examples of information include measurement information from sensors 804, condition information regarding system 800 (e.g., the power state, network connectivity, and operational status of one or more components of system 800), and information regarding the operational parameters of system 800 (e.g., user preferences, system settings, configurable system options, and so forth). A user can also interact with monitoring module 826 in order to configure system 800, for example by specifying or modifying user preferences, system settings, configurable system options, and so forth.

A schematic of an example implementation of monitoring module 826 is shown in FIG. 9. Monitoring module 826 includes an access portal 902. Access portal 902 acts as an initial point of interaction for the user, and can include, for example, identifying information regarding the system 800.

Once a user navigates through the access portal 902, the user is presented with a login screen 904. Login screen 904 allows the user to enter access credentials, for example a user name, password, or other authentication information.

Once a user's identity is authenticated, module 826 presents a variety of information to the user. This information may be adapted based on the user's identity and on his corresponding permission level. For example, if the user has a high permission level (e.g., if the user is a “super admin”), the user might be presented with a global view 906. Global view 906 might present, for instance, information regarding all aspects of system 800. If the user has a lower permission level (e.g., if the user is an “admin”), the user might be presented with an enterprise view 908. Enterprise view 908 might present, for instance, information regarding a subset of information regarding system 800. As an example, enterprise view 908 might present information that is relevant specifically to the user's organization (i.e., “enterprise”) or information related to the user's level of responsibility. If the user has a lower permission level (e.g., if the user is an “admin” or worker with a lower degree of responsibility), the user might be presented with a campus view 910. Campus view 910 might present, for instance, information regarding a smaller subset of information regarding system 800. As an example, campus view 910 might present information that is pertinent to one or more locations for which the user is responsible. While example user levels and views are described, other user levels and views can be used to provide a greater or lesser degree of granularity to user permissions and access restrictions. For example, in some implementations, user levels can include a “store manager,” a “regional manager,” and a “corporate manager,” with each successive management level granting successively greater access to module 826.

Each view can include a variety of modules that allow a user to view and modify information. As an example, a view can include a profile module 912, a statistics module 914, an alerts and messages module 916, a viewer module 918, an activity module 920, and a settings module 922.

Profile module 912 allows the user to view and edit information relating to the user's identify and his personal preferences. For example, a user can interact with profile module 912 to view and modify his identifying information, authentication credentials, contact information, user preferences, and other information that relates to the user.

Statistics module 914 allows the user to view information regarding various statistics related to the operation of system 800. For example, in some implementations, statics module 914 can display the uptime of one or more of the components of system 800 (e.g., sensors 804, server 806, server 818, etc.).

Viewer module 916 allows the user to view information regarding the monitoring functionality of system 800. For instance, viewer module 916 can display a locational view of the sensors 804. In an example implementation, the location of each sensor 804 can be displayed as an overlay of a map or aerial imagery. Viewer module 916 can display all of the sensors 804, or subsets of the sensors 804 (e.g., sensors from a particular physical area or sensors that the user is responsible for maintaining) For instance, in some implementations, viewer module 916 can display groups of sensors 804 (i.e., arrays or “nodes”), or individual sensors 804.

Viewer module 916 can also display the measurements obtained from sensors 804. Viewer module 916 can display measurements in real-time or near real-time (such that a user can view the current conditions in a particular location), or it can display a historical collection of measurements (such that a user can view historical trends over a period of time). In some implementations, viewer module 916 can display a pictorial presentation of measurements (e.g., as a graph, gauge, or other visual indicator) and an overlay that indicates certain important or critical values. As an example, viewer module 916 can display a historical graph of load measurements obtained by sensors 804, and can overlay a line that indicates a threshold load value above which the load is considered to be dangerously high. This allows a user to visually assess each measurement, and to quickly determine if the measurement is approaching or has exceeded critical values.

Viewer module 916 can also display additional information, for instance overhead imaging data (e.g., images taken from satellite or aerial images), pending alert messages, weather information (e.g., weather forecasts, reports, and other weather-related information), camera data (e.g., video and/or audio taken from cameras positioned in the vicinity of sensors 804 or elsewhere), or mapping data.

Activity module 918 allows the user to view information regarding the service history of the system 800. For instance, activity module 918 can display a log of service and maintenance activities performed to the system 800, and can display a list of upcoming service and maintenance requirements.

Alerts and messages module 920 allows the user to view and send alerts and messages. These alerts and messages can be related to the operation of system 800, the weather, or any other topic. As an example, module 920 may alert a user when a monitored location is experiencing, or is predicted to experience, a severe weather condition (e.g., a storm, heavy rain, high wind, etc.) In another example, module 920 may alert a user when a component of system 800 is in need of service (e.g., if a component has lost power, is malfunctioning, or is performing erratically). In some implementations, module 920 may allow users to send and receive messages to other users. As an example, a user interacting with server 818 may send and receive messages from a user interacting with server 806. In another example, two users interacting with service 818 may send and receive messages to each other.

Settings module 922 allows the user to view and modify various settings for system 800. For instance, settings module 922 can display settings related to the sensors 804, servers 806 and 818, or any other component of system 800. Example settings include criteria specifying when sensors 804 are operational, what type of measurements are conducted by sensors 804, how often sensors 804 make measurements, how often sensors 804 communicate with server 806, and any other criteria related to the operation of system 800. Other example settings include profile settings (e.g., information specifying the location of sensor arrays/nodes, sensors, and search [[???]]), weather settings (e.g., settings specifying the use of a particular weather service), map settings (e.g., settings specify the use of a particular mapping service), service settings (e.g., information regarding service providers, equipment dealers, and export/share logs), default settings (e.g., settings that dictate the default operational behavior of the nodes and sensors), notification settings (e.g., settings dictating the behavior of inbound and output messages), and account settings (e.g., information regarding the user's identifying information, authentication credentials, permission level, and other account-related information). In some implementations, settings module 922 allows a user to administrate access permissions to module 826. For instance, a user with a high permission level (e.g., a “super admin” or “admin”) can set and modify the permission level of other users, and can add and/or remove functions available to the other users. While several example settings are described, settings module 922 can be used to adjust any other setting related to the operation of system 800.

In some implementations, modules can interact with each other during the operation of system 800. For instance, weather data from the viewer module 916 can be used to adjust the settings of settings module 922. As an example, if weather data from the viewer module 916 indicates that a severe storm is approaching, settings module 922 can adjust the operation of sensors 804, such that the sensors 804 are operational, conduct measurements more frequently, and transmit measurements to server 806 more frequency during the storm.

In another example, when an alert concerning severe weather is received by module 920, settings module 922 can adjust the operation of sensors 804, and viewer module 916 can display relevant weather-related information and a map of the affected area.

In another example, when activity module 918 detects that service is needed to a component of system 800, alerts and messages module 920 can send an alert to one or more users of system 800.

While several modules are described, these modules are provided merely as examples. Each view may contain fewer or additional modules, and may include other modules to expand the functionality of system 800. Likewise, while several inter-module interactions are described, these are provided merely as examples, and the modules of system 800 can share information and interact in other ways.

In some implementations, system 800 can be operated as a part of a monitoring service. For instance, a monitoring organization can maintain and operate all or part of system 800 in order to monitor locations on behalf of clients (e.g., building owners or administrators). As an example, a monitoring organization can operate system 800, and “subscribe” clients to monitoring services on an ongoing basis.

In some implementations, server 806 and 818 can be operated by a monitoring organization, and the monitoring organization contacts a client when a critical situation is detected. For example, when sensors 804 indicate a critical situation to a client's building, the monitoring organization can use system 800 to contact the appropriate client to inform him of the situation. In some cases, the monitoring organization can also permit its clients individual access to server 806 and 818, for example at a limited permission level with restricted functionality.

An example implementation of a method of reporting an activated monitoring device comprises a load condition being applied to a monitor (1410), wherein the monitor is a single monitor or part of an array of monitors; the monitor sends a wireless signal to a control unit (1415) that the monitor has experienced a load condition; the control unit identifies the monitor and transmits an alert over a network to a server (1420); the server receives the alert condition (1420) and initiates the alert notification protocol (1430); wherein an electronic mail, an instant message, a text message, a telephone call, a page, or any other suitable communication is automatically sent from the server to one or more client contacts (1440), a pre-identified third-party service provider (1447), and/or one or more additional contacts (1444); the alert notification is acknowledged with in a preset time frame (1445) and the event is recorded (1447). In the alternative, if the alert notification is not acknowledged within a preset time frame (1450), the server automatically alerts a call center operator (1452). Upon notification of the alert, the call center operator may acknowledge the alert and the event is recorded (1453) In addition, upon acknowledgement of the alert, the server provides the call center operator with additional client contacts for notification of the alert condition (1454), wherein the call center operator has the information to reach a client contact in person to assure the alert condition is not ignored. In some embodiments, the server can automatically alert a monitoring service employee, contact or executive, separate from the call center operator at any point after server receives notification of the alert condition from the controller. The server can be programmed to continuously alert a call center operator and or a monitoring service contact or executive if the customer fails to acknowledge the alert either from the automatic notification or from the call center manual notification.

An example of a method of prioritizing alert notifications within a roof monitoring system comprises, a first load sensor experiences a load condition 1520 and a second sensor in a separate system experience a load condition 1530. The first and second sensors send an alert to their respective system controllers, the alert may be sent by a wireless signal (1521, 1531). The respective controllers receive the alert signals from their respective load monitors and determine an alert condition based on preset variables (1522, 1532). The present load conditions determined by each controller can be categorized, for example, red, orange, yellow and green, depending on the level and type of load relative to the structure or environment being monitored. Each controller sends the alert with the alert categorization to a monitoring server (1524, 1534) via network such as the internet. The server then follows a client specific alert notification protocol and notifies one or more client contacts via message, e-mail, page, telephone conversation, or other communication medium (1526, 1536). If the client contact does not acknowledge the notification within a preset time the server will order all alert notifications from different systems according to categorization priority (1545). For example, red categorized alerts will be first, with orange, yellow and green categorized alerts following in order. Additional factors may be used to order alert notifications within the server, for example time since alert condition, escalating categorization of alert condition, weather conditions or forecasts, type of structure, level of account (premium versus a standard account), etc. The server then presents the highest categorized unacknowledged alert to a call center operator and/or other monitoring service employee for further client notification protocol procedures.

The devices, systems and methods described herein can be used to monitor load conditions, for example on a roof. In addition to snow, standing water, debris, or wind loads, the system can also monitor whether persons or objects are standing on or near a particular feature of the structure. For example, the system can incorporate one or more mats in addition to load sensors, wherein the mats are incorporated into the sensor array and can determine if a person or animal is stepping on or walking on the mat. Examples of such mats include safety mats manufactured by Pinnacle Systems of Pickering, Ontario, Canada. Incorporation of such mats an alert a control monitor and subsequent server and call center to the presence of personnel on a roof or near critical equipment or hazardous areas, such as a sky light or access point.

The devices systems and methods described herein can be used to monitor load conditions, environmental conditions and/or occurrences of specific events in various settings, such as machinery rooms and spaces, storage spaces, cold rooms, basements, void spaces, or any other area where traffic by personnel is infrequent or hazardous, or a deviation from normal operating environmental conditions should be monitored. For example, the system described herein can be incorporated in a machinery room, such as boiler room or server room to detect moisture accumulation, the presence of standing water, increases in temperature, motion from personnel in the space, etc. In this way the monitoring system described herein can receive alerts from incorporated sensors. The monitoring system can be networked with control features to equipment in monitored spaces, wherein upon the occurrence of an alert event, such as the presence of moisture, smoke, standing water, etc., operational features of key equipment can be deactivated or activated. In some embodiments the functional ability to deactivate or activate equipment in a monitored space can be initiated by call center personnel receiving notification of an alert condition.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. An apparatus comprising:
a protective top cover having a load transfer assembly;
a bottom plate attachable to the top cover, the bottom plate including a circuit board comprising;
a load sensor,
a power source; and
a wireless processor;
wherein the circuit board is configured on the bottom plate such that the load transfer assembly of the top plate is in contact with the load sensor.

2. A method performed by data processing apparatus, the method comprising:
periodically monitoring the load condition over a specified area using one or more networked load sensors;
connecting a load sensor with a local network, receiving at sensor base station a load condition measured by at least one load sensor;
processing the load condition and determining whether such load condition is within a specified parameter; and
reporting the load condition to a user over a network.

3. The method of claim 2 wherein the load sensor comprises a roof load sensor, a safety mat, a wind sensor or a barometer.

4. A computer storage medium encoded with a computer program, the program comprising instructions that when executed by data processing apparatus cause the data processing apparatus to perform operations comprising:
periodically monitoring the load condition over a specified area using one or more networked load sensors;
connecting a load sensor with a local network, receiving at sensor base station a load condition measured by at least one load sensor;
processing the load condition and determining whether such load condition is within a specified parameter; and
reporting the load condition to a user over a network.

5. A system comprising:
a base station;
a sensor array having one or more load sensor, wherein the load sensors comprise a protective top cover having a load transfer assembly;
a bottom plate attachable to the top cover, the bottom plate including a circuit board comprising;
a load sensor,
a power source; and
a wireless processor;
wherein the circuit board is configured on the bottom plate such that the load transfer assembly of the top plate is in contact with the load sensor;
wherein the load sensors are in wireless communication with a base station server;
wherein the base station server receives periodic load condition reports from the load sensors in the sensor array, processes the load conditions into a user readable report and transmits the user readable report to a user terminal over network.

6. The system of claim 4, wherein the one or more computers comprise a server operable to interact with the load sensor through a data communication network, and the load sensor is operable to interact with the server as a client.

7. The system of claim 6 wherein the load sensor configured to detect a static load.

8. The system of claim 6 where in the load sensor is configured to detect a person or animal stepping on the load sensor.

9. The system of claim 6 wherein the load sensor detects wind speed or wind force.

10. The system of claim 6 wherein the load sensor detects barometric pressure.

11. The system of claim 6 comprising multiple load sensors configured to detect a static load, a person or animal walking on the sensor, wind speed or force, or barometric pressure.
